(19) United States
(12) Patent Application Publication
(10) Pub. No.: US 2025/0385327 A1
(43) Pub. Date: Dec. 18, 2025

(54) BATTERY TEST APPARATUS

(71) Applicant: TOYO SYSTEM CO., LTD., Iwaki-shi, Fukushima (JP)

(72) Inventors: Jun OMORI, Fukushima (JP); Kenji YAMANOBE, Fukushima (JP); Hideki SHOJI, Fukushima (JP)

(73) Assignee: TOYO SYSTEM CO., LTD., Iwaki-shi, Fukushima (JP)

(21) Appl. No.: 18/684,183

(22) PCT Filed: Nov. 22, 2022
(86) PCT No.: PCT/JP2022/043241

§ 371 Date: Mar. 24, 2025

(30) Foreign Application Priority Data
Feb. 28, 2022 (JP) 2022-029217

(51) Int. Cl. H01M 10/42; H01M 10/44; H01M 50/204; H01M 50/244; H01M 50/317; H01M 50/358

(52) U.S. Cl. CPC H01M 10/4285; H01M 10/441; H01M 50/244; H01M 50/317; H01M 50/358; H01M 50/204

(57) ABSTRACT

A battery test apparatus includes an enclosed battery holder which detachably holds a secondary battery, a thermostatic oven in which the battery holder is held, and a charge and discharge test device which charges and discharges the secondary battery held in the battery holder to test the secondary battery. The battery holder is constituted of a fireproof and pressure resistant container capable of withstanding ignition of the secondary battery. Since an exhaust port is connected to an exhaust pipe which discharges gas in the battery holder when the secondary battery ignites, the exhaust port discharges the gas to the outside of the thermostatic oven to release its pressure.

### TECHNICAL FIELD

The present invention relates to a battery test apparatus which performs a charge/discharge test of a secondary battery.

### BACKGROUND ART

There has heretofore been known a test apparatus which is configured so that mounting parts of a plurality of secondary batteries for test can be put in and taken out of a thermostatic oven to thereby test the secondary batteries. The secondary batteries are subjected to a charge/discharge test at a predetermined environmental temperature (for example, Patent Literature 1).

As a result of the charge/discharge test, some secondary batteries ignite. Although Patent Literature 1 does not refer to what to do in the case of ignition, for example, there were a method of detecting generated smoke and supplying water to the inside of a battery holder to extinguish the ignited secondary battery, etc.

### CITATION LIST

### Patent Literature

Patent Literature 1: Japanese Patent No. 5738660

### SUMMARY OF INVENTION

### Technical Problem

However, in the thermostatic oven, a plurality of battery holders are arranged

with almost no space between them. Therefore, upon extinguishing with water, the water enters the adjacent battery holders, which may affect the charge/discharge test of the non- ignited secondary battery.

The present invention has been made in view of such circumstances. It is an object of the present invention to provide a battery test apparatus capable of performing a charge/discharge test of a secondary battery without using water or the like.

### Solution to Problem

In order to achieve the above object, the present invention provides a battery test apparatus which performs a charge/discharge test of each of secondary batteries. The battery test apparatus includes an enclosed battery holder which detachably holds the secondary battery, a thermostatic oven in which the battery holder is held, and a charge and discharge test device which charges and discharges the secondary battery held in the battery holder to test the secondary battery. The battery holder is constituted of a fireproof and pressure resistant container capable of withstanding the ignition of the secondary battery and being provided with an exhaust port connectable to a passage through which gas in the battery holder is discharged to the outside of the thermostatic oven when the secondary battery ignites.

When testing the secondary batteries by using the battery test apparatus of the present invention, some secondary batteries may catch fire. The battery holder for the secondary battery is constituted of the fireproof and pressure resistant container and hermetically holds the secondary battery. Therefore, it is possible to basically confine the gas (exhaust gas) generated by the ignition and prevent the gas from leaking to the outside.

Further, the battery holder has the exhaust port connected to the passage which discharges the gas generated by the ignition. Therefore, the gas can be guided to the outside of the thermostatic oven through the passage and released in pressure. Thus, even if the ignition of the secondary battery occurs, the battery test apparatus of the present invention can treat it without using water or the like.

In the battery test apparatus of the present invention, it is preferable that the battery holder includes a plurality of chambers divided for each of the secondary batteries, and the battery holder is capable of detachably holding the secondary battery for each of the chambers and is provided for each chamber with the exhaust port which guides the gas in the chamber to the passage.

According to this configuration, each chamber holding the secondary battery in the battery holder has the exhaust port which guides the gas (exhaust gas) in the chamber to the passage. Therefore, when the secondary battery ignites due to testing, the gas can be discharged from the chamber and released in pressure. Consequently, the battery test apparatus of the present invention can reliably test each secondary battery without affecting the adjacent secondary batteries.

Further, in the present invention, it is preferable that a plurality of the battery holders are held in parallel in the thermostatic oven.

According to this configuration, since the battery holders are held in parallel in the thermostatic oven, the multiple secondary batteries can be tested simultaneously. Even if there is a secondary battery that ignites in the test, it does not affect the adjacent battery holders because the battery holder is a closed type.

In addition, in the battery test apparatus of the present invention, it is preferable to provide a first common passage through which the gases discharged from the plurality of battery holders are made to flow, and which discharges the same to the outside of the thermostatic oven.

According to this configuration, in each battery holder holding the secondary battery therein, each internal gas (exhaust gas) is collected to the first common passage through the exhaust port. Then, the gas flows through the first common passage and is discharged to the outside of the thermostatic oven. Therefore, the battery test apparatus of the present invention can reliably discharge the gas to the outside without the gas leaking out in the thermostatic oven.

Further, in the battery test apparatus of the present invention, it is preferable that each of the battery holders has a first check valve which allows exhaust to the first common passage and prevents inflow from the first common passage.

The first check valve of each battery holder allows exhaust to the first common passage, but prevents inflow from the first common passage to each battery holder. Therefore, it is possible to prevent the gas (exhaust gas) flowing through the first common passage from flowing back into each battery holder.

Further, in the battery test apparatus of the present invention, it is preferable that it has a second common passage as the passage, which merges the gases discharged from the exhaust ports and discharges the same to the outside of the thermostatic oven, and that each of the exhaust ports has a second check valve which allows exhaust to the second common passage and prevents inflow from the second common passage.

According to this configuration, the gas (exhaust gas) discharged from each exhaust port flows through the second common passage and is discharged to the outside of the thermostatic oven. Further, the exhaust port has the second check valve. The second check valve allows exhaust to the second common passage, but prevents inflow from the second common passage. Therefore, it is possible to prevent the gas flowing through the second common passage from flowing back into the chamber.

### BRIEF DESCRIPTION OF DRAWINGS

FIG. 1 is an overall view of a battery test apparatus according to a first embodiment of the present invention.

FIG. 2 is a side view of the battery test apparatus according to the first embodiment.

FIG. 3 is a perspective view of a battery holder according to the first embodiment.

FIG. 4 is a view of the battery holder according to the first embodiment when viewed from above (without an upper cover).

FIG. 5 is an overall view of a battery test apparatus according to a second embodiment of the present invention.

FIG. 6 is a view of a battery holder according to the second embodiment when viewed from above (without an upper cover).

### DESCRIPTION OF EMBODIMENTS

### First Embodiment

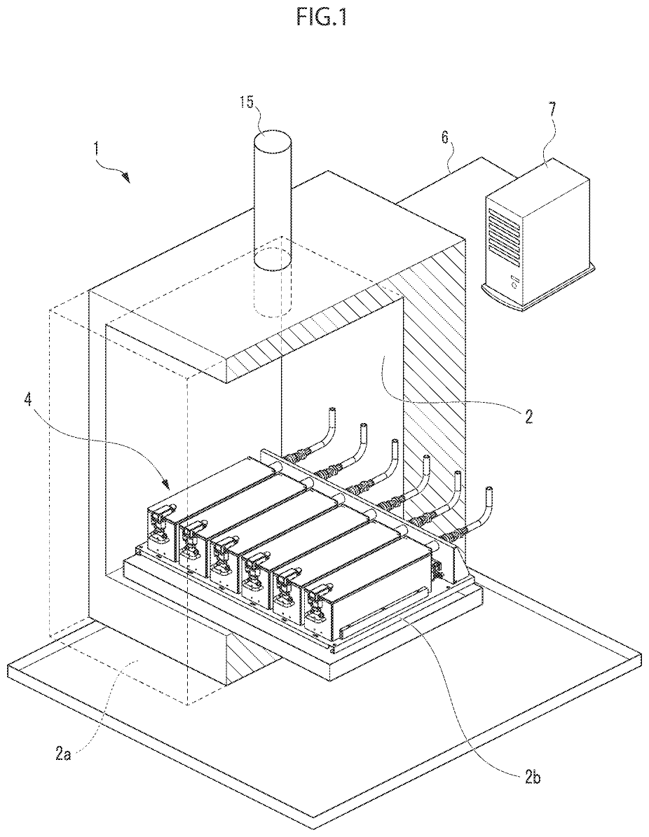

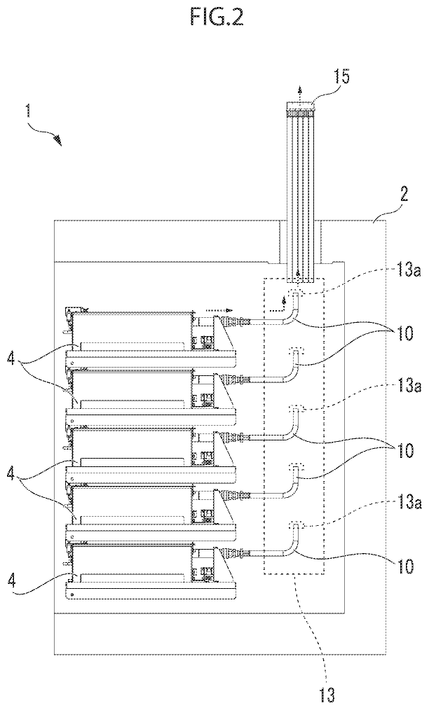

First, a battery test apparatus 1 according to the first embodiment of the present invention will be described with reference to FIGS. 1 and 2.

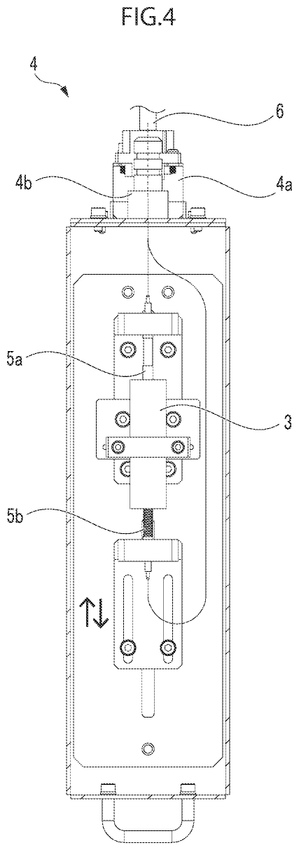

FIG. 1 is an overall perspective view of the battery test apparatus 1. For the sake of explanation, the inside of a thermostatic oven 2 is set to be made visible. The battery test apparatus 1 is an apparatus which evaluates secondary batteries by charging and discharging the secondary batteries. The battery test apparatus 1 includes the thermostatic oven 2 which keeps its internal temperature constant, a plurality of battery holders 4 which are accommodated in the thermostatic oven 2 and detachably hold the secondary batteries 3, and a charge and discharge test device 7 capable of charging and discharging the secondary battery 3 (refer to FIG. 4) via a contact probe 5 and a cable 6.

The thermostatic oven 2 is an apparatus controlled to keep the internal temperature constant by circulating temperature-controlled air and has a structure capable of preventing the influence of temperature changes from the surrounding environment.

A slide rail 2b which guides the slide of the battery holders 4 is provided in the thermostatic oven 2. Further, a one-sided open/close door 2a is provided in front of the thermostatic oven 2. The battery holder 4 can be freely drawn from the front of the thermostatic oven 2 along the slide rail 2b by opening the open/close door 2a of the thermostatic oven 2.

The battery holders 4 are accommodated in parallel in the thermostatic oven 2. Although the battery holders 4 of the lowermost stage are shown in FIG. 1 for the sake of description, a total of five stages of six battery holders 4 are actually placed per stage as shown in FIG. 2. The placement of the battery holders 4 is not limited to this, and can be changed as appropriate.

In the thermostatic oven 2, each of the battery holders 4 is connected to the charge and discharge test device 7. The charge and discharge test device 7 is capable of performing a charge/discharge test on the secondary battery 3 in the battery holder 4.

The battery holder 4 in the first embodiment is a rectangular parallelepiped holder (single channel type) capable of holding one secondary battery 3 detachably and hermetically. This battery holder 4 serves as a fireproof and pressure resistant container which can withstand even if the secondary battery 3 ignites due to the charge/discharge test.

When some secondary batteries 3 ignite due to the charge/discharge test, as shown in FIG. 2, exhaust gas is discharged from an exhaust pipe 15 protruded above the thermostatic oven 2 to the outside of the thermostatic oven 2 via a flexible hose 10 from an exhaust port of the battery holder 4. A configuration may be taken in which the exhaust gas is guided to the exhaust pipe 15 via a common passage 13 (“first common passage” in the present invention) from the flexible hose 10 of the battery holder 4. Incidentally, the flow of the exhaust gas is as indicated by dotted arrows.

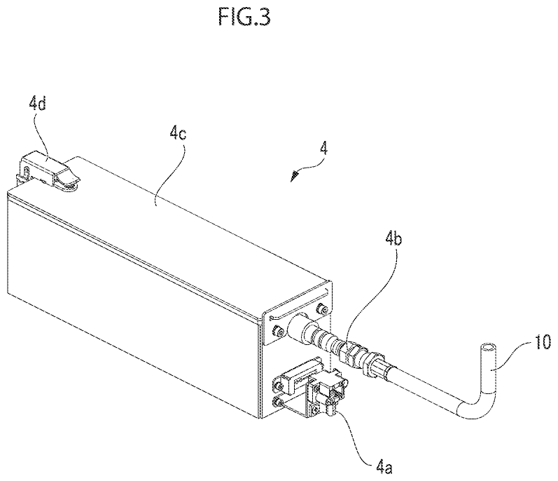

The details of the battery holder 4 will next be described with reference to FIGS. 3 and 4.

First, FIG. 3 is a perspective view of the hermetically sealed battery holder 4. A connector 4a and an exhaust port 4b are provided on one side surface (right side in the figure) of the battery holder 4. The connector 4a is a connector which connects the battery holder 4 and a cable 6 extending from the charge and discharge test device 7.

Further, the exhaust port 4b is an opening for discharging gas in the battery holder 4 to its outside. The exhaust port 4b is configured to be connectable to the flexible hose 10 (“passage” in the present invention) which guides the gas to the outside of the thermostatic oven 2.

An upper surface side of the battery holder 4 is an upper cover 4c which opens and closes when the secondary battery 3 is put in and taken out. The upper cover 4c is fixed on the other side surface (the side opposite to the connector 4a) of the battery holder 4 by a lock mechanism 4d.

Next, FIG. 4 shows the manner when the upper cover 4c of the battery holder 4 is removed. In the battery holder 4, the secondary battery 3 (cylindrical type) can be set approximately in the center thereof. Both a positive electrode contact probe pin 5a and a negative electrode contact probe pin 5b are connected to the cable 6 of the charge and discharge test device 7.

The contact probe pin 5a is made to contact with the secondary battery 3 on the upper side of the secondary battery 3 in the figure. Further, the contact probe pin 5b is configured to be movable in a vertical direction and is made to contact with the secondary battery 3 from the side below in the figure. Consequently, the secondary battery 3 can be tested by the charge and discharge test device 7. Since the battery holders 4 are held in parallel in the thermostatic oven 2 as illustrated in FIGS. 1 and 2, the battery test apparatus 1 can test the plurality of secondary batteries 3 simultaneously.

When testing the secondary batteries 3, some secondary batteries 3 catch fire. However, the battery holder 4 is constituted of the fireproof and pressure resistant container and hermetically holds the secondary batteries 3. Therefore, it is possible to basically confine gas (exhaust gas) generated by the ignition within the battery holder 4 and prevent the gas from leaking to the outside.

The exhaust gas generated by the ignition is discharged through the flexible hose 10 from the exhaust port 4b. The exhaust gas flows from the flexible hose 10 to the exhaust pipe 15 (refer to FIG. 2) and can be led to the outside of the thermostatic oven 2 and released in pressure. Thus, even if the ignition of the secondary battery 3 occurs, the battery holder 4 of the present embodiment can treat it without using water or the like, and prevents the exhaust gas from leaking out within the thermostatic oven 2. Further, when there is a secondary battery 3 that catches fire, its battery holder 4 does not affect the adjacent battery holder 4.

In the case of a configuration in which the flexible hose 10 of each battery holder 4 is inserted into the common passage 13 (refer to FIG. 2), a check valve 13a (“first check valve” in the present invention) may be provided in the common passage 13. The check valve 13a is structured to be opened by wind pressure of the exhaust gas in the battery holder 4. The check valve 13a allows exhaust to the common passage 13, but prevents inflow from the common passage 13 to the battery holder 4. Therefore, it is possible to prevent the exhaust gas flowing through the common passage 13 from flowing back into each battery holder 4.

The battery holder 4 may be configured to be able to test a secondary battery other than a cylindrical type. For example, in the case of secondary batteries of laminate cell specifications, each secondary battery can be tested by clamping each electrode with a current contact clip and a voltage contact clip. It is also possible to test secondary batteries of square cell specifications by a similar method.

### Second Embodiment

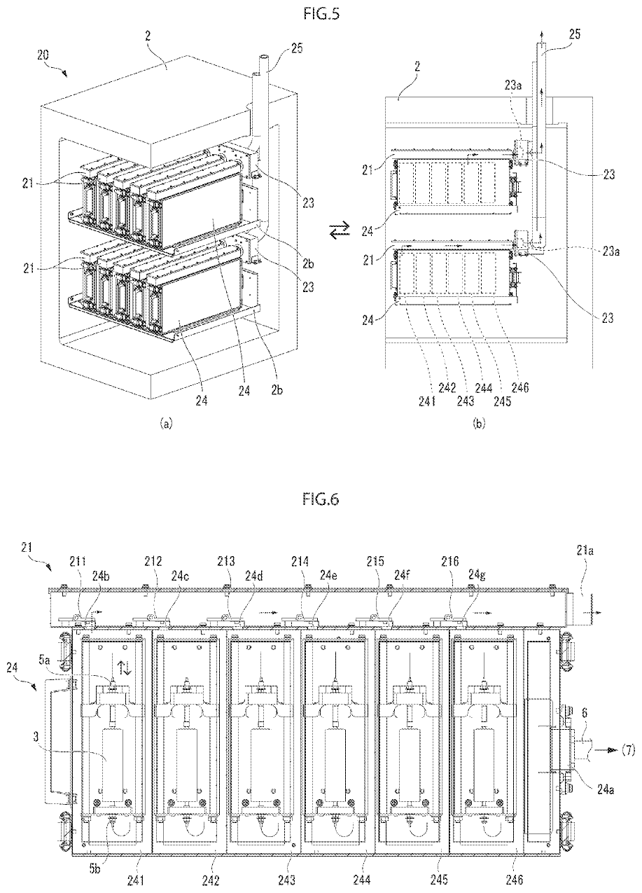

Next, a battery test apparatus 20 according to a second embodiment of the present invention will be described with reference to FIGS. 5 and 6. Incidentally, the same components as those of the battery test apparatus 1 of the first embodiment are denoted by the same reference numerals, and the description thereof will be partly omitted.

FIG. 5 is an overall perspective view of the battery test apparatus 20. For the sake of explanation, the inside of a thermostatic oven 2 is set to be made visible. As illustrated in FIG. 5A, the battery test apparatus 20 includes a thermostatic oven 2, a plurality of battery holders 24 which are accommodated in the thermostatic oven 2 and detachably hold secondary batteries 3, and a charge and discharge test device 7 (not shown) capable of charging and discharging the secondary batteries 3.

The battery holders 24 are held in parallel in the thermostatic oven 2. In the present embodiment, a total of two stages are arranged with five battery holders 24 as one stage. The arrangement of the battery holders 24 is not limited to this, and can be changed as appropriate. Further, slide rails 2b to guide the slide of the battery holders 24 are provided within the thermostatic oven 2, and the battery holders 24 can be freely drawn from the front of the thermostatic oven 2 along the slide rails 2b.

FIG. 5B is a side view of the battery test apparatus 20. Each battery holder 24 has an inside divided into six chambers 241 to 246. That is, the battery holder 24 is a rectangular parallelepiped holder (multi-channel type) capable of holding one secondary battery 3 in each of the chambers 241 to 246 detachably and hermetically. Incidentally, the number of the chambers in the battery holder 24 can be changed as appropriate.

A common passage 21 (“second common passage” in the present invention) in the thermostatic oven 2 for discharging the exhaust gas is provided above each battery holder 24. Although details will be described later, each of the chambers 241 to 246 of the battery holder 24 has an exhaust port, and the exhaust gas discharged from each exhaust port joins at the common passage 21.

At the leading end of each common passage 21, one common passage 23 (“first common passage” in the present invention) is provided for each stage. The common passage 23 is a common passage in which gases from the five battery holders 24 merge. Further, each common passage 23 is connected to each of exhaust pipes 25, and the tip of each exhaust pipe 25 protrudes from the thermostatic oven 2. Thus, the exhaust gas flows from the exhaust ports of the chambers 241 to 246 through the common passage 21, the common passage 23, and the exhaust pipe 25 in this order, and is discharged to the outside of the thermostatic oven 2. Incidentally, the flow of the exhaust gas is as indicated by broken line arrows.

FIG. 6 shows the manner when an upper cover of the battery holder 24 is removed. In the battery holder 24, the inside thereof is divided into the chambers 241 to 246, and one secondary battery 3 (cylindrical type) can be set to each of the chambers 241 to 246.

Both a positive electrode contact probe pin 5a and a negative electrode contact probe pin 5b are connected to a cable 6 connected to the charge and discharge test device 7. Incidentally, the battery holder 24 and the cable 6 of the charge and discharge test device 7 are connected through a connector 24a provided on one side surface (right side in the figure) of the battery holder 24.

The upper side of the secondary battery 3 in the figure is made to contact with the contact probe pin 5a. The contact probe pin 5a is configured to be movable in a vertical direction in the figure and is made to contact with the secondary battery 3 from the upper side in the figure. Further, the lower side of the secondary battery 3 in the figure is made to contact with the contact probe pin 5b. Thus, the secondary battery 3 can be subjected to a charge/discharge test by the charge and discharge test device 7.

When testing the secondary batteries 3, some secondary batteries 3 catch fire. However, each of the chambers 241 to 246 in the battery holder 24 is constituted of a fireproof and pressure resistant container and hermetically holds the secondary batteries 3. Therefore, it is possible to basically confine the exhaust gas generated by ignition and prevent the exhaust gas from leaking to the outside.

When the exhaust gas is generated by the ignition, it is discharged from the exhaust ports 24b to 24g. For example, when the secondary battery 3 in the chamber 241 ignites, the generated exhaust gas flows out from the exhaust port 24b. A check valve 211 (“second check valve” in the present invention) connected to the common passage 21 is provided above the exhaust port 24b.

The check valve 211 has a mechanism to open it by wind pressure of the exhaust gas. Specifically, there is provided a structure in which a cover portion of the check valve 211 covers the exhaust port 24b of the exhaust ports 24b to 24g. The cover portion rotates about the rotational axis and is biased toward each of the exhaust ports 24b to 24g by a spring. When the cover portion receives wind pressure, it rotates to separate from each of the exhaust ports 24b to 24g and open.

The check valves 211 to 216 allow exhaust to the common passage 21, but prevent inflow from the common passage 21 into the chambers 241 to 246. Therefore, the exhaust gas flowing through the common passage 21 can be prevented from flowing back into the chambers 241 to 246.

A connection portion 21a at the end (right side in the figure) of the common passage 21 is connected to the common passage 23. As shown in FIG. 5B, a check valve 23a (“first check valve” in the present invention) may be provided in the common passage 23. The check valve 23a is of the form that is opened by the wind pressure of the exhaust gas from the common passage 21 and allows exhaust to the common passage 23, but prevents inflow from the common passage 23 to the common passage 21. Therefore, it is possible to prevent the exhaust gas flowing through the common passage 23 from flowing back into the common passage 21 and each battery holder 24.

Thus, in the battery test apparatus 20, the exhaust gas can be guided to the outside of the thermostatic oven 2 and released in pressure. Even if the ignition of the secondary battery 3 occurs, the battery holder 24 in the present embodiment can treat it without using water or the like, and can discharge the exhaust gas to the outside without the exhaust gas leaking out within the thermostatic oven 2.

The present invention is not limited to the above embodiments, and can be implemented in various forms within the scope not departing from the gist of the invention. Although the battery test apparatus 1 (battery test apparatus 20) including the multiple battery holders 4 (battery holders 24) in the thermostatic oven 2 has been described in the above embodiments, the present invention is not limited to this. For example, the number of the battery holders 4 (battery holders 24) in the thermostatic oven 2 may be one.

Further, in the first embodiment, although the configuration has been described in which one secondary battery 3 is accommodated in the battery holder 4, the present invention is not limited to this. For example, a plurality of secondary batteries 3 may be configured to be able to be held within one battery holder 4.

In the battery test apparatus 1 according to the first embodiment, the check valve 13a is provided in the common passage 13, but the check valve may be provided in the exhaust port 4b of the battery holder 4, and either one of them may be provided. Further, in the battery test apparatus 20 according to the second embodiment, the check valves 211 to 216 are provided in the common passage 21, and the check valve 23a is provided in the common passage 23, but either one of them may be provided.

### DESCRIPTION OF REFERENCE NUMERALS

1 battery test apparatus
2 thermostatic oven
2a open/close door
2b slide rail
3 secondary battery
4 battery holder (single channel type)
4a connector
4b exhaust port
4c upper cover
4d lock mechanism
5 contact probe
5a contact probe pin (positive electrode)
5b contact probe pin (negative electrode)
6 cable
7 charge and discharge test device
10 flexible hose
13 common passage
13a check valve
15 exhaust pipe
20 battery test apparatus
21 common passage
211-216 check valve
23 common passage
23a check valve
24 battery holder (multi-channel type)
25 exhaust pipe
241-246 chamber

1. A battery test apparatus which performs a charge and discharge test of each of secondary batteries, comprising:
an enclosed battery holder which detachably holds the secondary battery;
a thermostatic oven in which the battery holder is held; and
a charge and discharge test device which charges and discharges the secondary battery held in the battery holder to test the secondary battery,
wherein the battery holder is configured by a fireproof and pressure resistant container capable of withstanding an ignition of the secondary battery and provided with an exhaust port connectable to a passage through which gas in the battery holder is discharged to outside of the thermostatic oven when the secondary battery ignites.

2. The battery test apparatus according to claim 1, wherein the battery holder includes a plurality of chambers divided for each of the secondary batteries, and
wherein the battery holder is capable of detachably holding the secondary battery for each of the chambers and is provided for each of the chambers with the exhaust port which guides the gas in the chamber to the passage.

3. The battery test apparatus according to claim 1, wherein a plurality of the battery holders are held in parallel in the thermostatic oven.

4. The battery test apparatus according to claim 3, including a first common passage which merges the gas discharged from the plurality of the battery holders and discharges the gas to the outside of the thermostatic oven.

5. The battery test apparatus according to claim 4, wherein each of the battery holders includes a first check valve which allows exhaust to the first common passage and prevents inflow from the first common passage.

6. The battery test apparatus according to claim 2, including a second common passage as the passage, which merges the gas discharged from the exhaust ports and discharges the gas to the outside of the thermostatic oven,
wherein each of the exhaust ports has a second check valve which allows exhaust to the second common passage and prevents inflow from the second common passage.
